(19) United States
(12) Patent Application Publication
(10) Pub. No.: US 2012/0016742 A1
(43) Pub. Date: Jan. 19, 2012

(54) SYSTEM AND METHOD FOR DISTRIBUTING ADVERTISEMENT-SUBSIDIZED E-BOOK

(76) Inventor: Peigen Jiang, Sammamish, WA (US)

(21) Appl. No.: 12/839,265

(22) Filed: Jul. 19, 2010

(51) Int. Cl. G06Q 30/00

(52) U.S. Cl. 705/14.49; 705/14.4

(57) ABSTRACT

A method for distributing an advertisement-subsidized e-book over the Internet is disclosed, the method comprises sending a selection page to a client device through the Internet, the selection page collecting a client's decision as to whether to order an e-book with or without advertisements, inserting at least one advertisement in a predetermined location of a digital copy of an ordered e-book, and transmitting the advertisement-inserted digital copy of the ordered e-book to the client device.

### BACKGROUND

The present invention relates generally to electronic books (e-book) delivered over the Internet, and, more particularly, to inserting advertisements in the e-books.

An e-book is an electronically displayed book equivalent of a conventional printed book. The electronic devices for displaying the e-book include personal computers, dedicated hand-held e-book readers and even some cell phones. E-book has many advantages such as lower production and distribution costs. It also helps the environment as there is no paper, ink or physical transportation involved in e-book consumption. E-books are generally cheaper than their printed counterparts. However due to the fact that writers, publishers and e-book sellers, etc., need to be compensated, most e-books are still considered expensive by many less privileged people, which may pose a limitation to the widespread of knowledge and joy of reading.

On the other hand, advertisers are seeking every opportunity to put their advertisements in front of people. E-book can be a medium to deliver advertisements. When e-books are subsidized by advertisements, their price to consumers can be lowered and become more affordable.

As such, what is desired is a system and method for allowing advertisements to subsidize e-books.

### SUMMARY

The present invention discloses a system and method for distributing an advertisement-subsidized e-book over the Internet. According to one aspect of the present invention, the distributing method comprises sending a selection page to a client device through the Internet, the selection page collecting a client's decision as to whether to order an e-book with or without advertisements, inserting at least one advertisement in a predetermined location of a digital copy of an ordered e-book, and transmitting the advertisement-inserted digital copy of the ordered e-book to the client device.

According to another aspect of the present invention, an advertisement manager program is transmitted to the client device along with the advertisement-inserted copy of the ordered e-book. The advertisement manager program can automatically remove the inserted advertisement from the digital copy of the ordered e-book after a predetermined condition is met. The predetermined condition includes a predetermined length of time since the e-book is received by the client device, an expiration date or a number of times the inserted advertisement is displayed in the client device

The construction and method of operation of the invention, however, together with additional objects and advantages thereof, will be best understood from the following description of specific embodiments when read in connection with the accompanying drawings.

### BRIEF DESCRIPTION OF THE DRAWING

FIG. 1 illustrates an e-book distribution system.

FIG. 2 illustrates a price-advertisement selection screen section according to an embodiment of the present invention.

FIG. 3 is a flow-chart diagram illustrating steps taken by an e-book seller for implementing the embodiment of the present invention.

FIG. 4 is a block diagram illustrating a computer system that performs the steps shown in FIG. 3.

The drawings accompanying and forming part of this specification are included to depict certain aspects of the invention. A clearer conception of the invention, and of the components and operation of systems provided with the invention, will become more readily apparent by referring to the exemplary, and therefore non-limiting, embodiments illustrated in the drawings, wherein like reference numbers (if they occur in more than one view) designate the same elements. The invention may be better understood by reference to one or more of these drawings in combination with the description presented herein.

### DESCRIPTION

The following will provide a detailed description of an e-book distribution method and system that allows advertisements to subsidize e-books and automatically removes inserted an advertisement from an e-book later on.

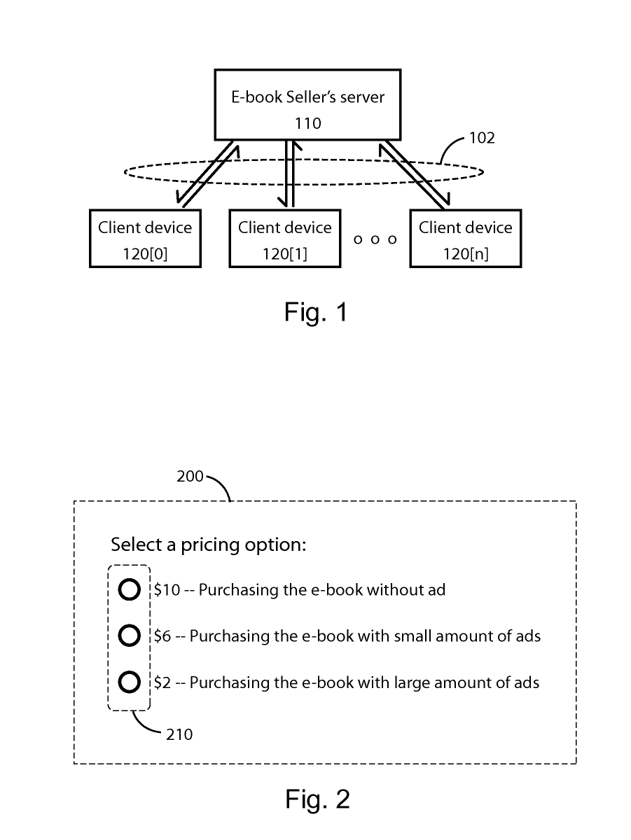

FIG. 1 illustrates an e-book distribution system. An e-book seller stores thousands or even millions of e-book in its server 110. A plurality of client devices 120[0:n], where n is an integer, can communicate to the e-book seller's server 110 through the Internet 102. The Internet 102 can be wired or wireless. Any one of the client devices 120[i], where i is an integer between 0 and n, can browse the e-book seller's catalog, make an e-book selection, purchasing and download the selected e-book.

FIG. 2 illustrates a price-advertisement selection screen section 200 according to an embodiment of the present invention. The screen section 200 is displayed on the client device 120[i] of FIG. 1. Three option-buttons 210 are presented on the screen section 200. Only one option can be selected. If a top option-button is clicked, a client chooses to purchase an e-book without any advertisement inserted—and pays a full price, $10, for the e-book. If a middle option-button is clicked, the client chooses to purchase the e-book with small amount of advertisements inserted—and pays a reduced price of $6. If a bottom option-button is clicked, the client chooses to purchase the e-book with large amount of advertisements inserted—and pays a deeply reduced price of $2. Apparently, the prices quoted above are arbitrary. An e-book can be listed and subsidized to any price. One having skill in the art would recognize that large amount of advertisements can allow selling an e-book for free.

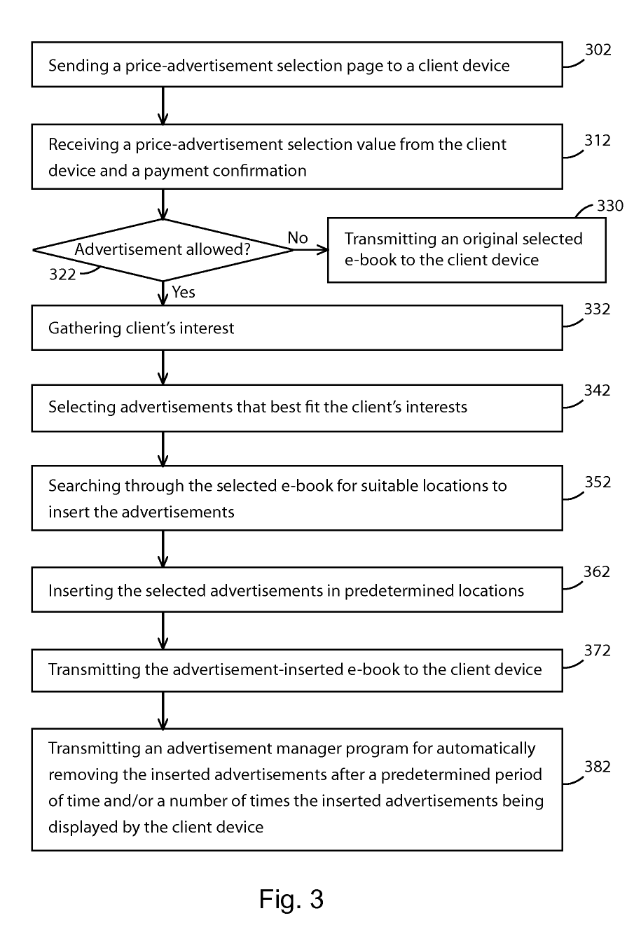

FIG. 3 is a flow-chart diagram illustrating steps taken by an e-book seller for implementing the embodiment of the present invention. Before the steps begin, of course, an e-book has to be selected or ordered by a client device for purchase (not shown). In step 302, the e-book seller (not shown) sends a price-advertisement selection page or screen section 200 as shown in FIG. 2 to a client device. In step 312, a price-advertisement selection value is received from the client device. The selection value reflects whether or not the client accepts advertisements inserted in the ordered e-book, and a level of the amount of advertisements inserted if they are acceptable. The e-book seller also receives a payment confirmation in step 312 before proceeding to subsequent steps. Apparently, if the e-book is made free by inserting advertisements, the receiving payment confirmation is unnecessary.

In step 322, the e-book seller detects if inserting advertisements in the ordered e-book is allowed by the client device. In case inserting advertisements is not allowed, the e-book seller then transmits a digital copy of the original e-book being ordered without any advertisement inserted to the client device in step 330. In case, inserting advertisements is allowed by the client device, the e-book seller gathers client's interests in step 332 by sending a client interest survey page to the client device and/or obtaining a subject of the ordered e-book. Based on the client's interests, the e-book seller selects advertisements from its database that best fit the client's interests in step 342. The number of selected advertisements corresponds to the level of amount of advertisements the client allows. In step 352, the e-book seller searching through the ordered e-book for suitable locations for inserting the selected advertisements. The suitable locations can be empty spaces on existing pages or added pages immediately subsequent to a cover page, table-of-content or end-of-chapter. In step 362, the e-book seller inserts the selected advertisements in the suitable locations in the selected e-book. In step 372, the selected e-book with the selected advertisements appropriately inserted is transmitted to the client device upon a request thereby. In step 382, the e-book seller also transmit, along with the selected e-book, an advertisement manager program to the client device for automatically removing the inserted advertisement from the copy of the ordered e-book after a predetermined period of time, an expiration date and/or a number of times the inserted advertisements being displayed by the client device. Because most advertisements are time sensitive. For instance, an advertisement for promoting a newly released movie may only be needed for a few weeks, while an advertisement for promoting an automobile may be relevant for a few years. On the other hand, it would be very much welcomed by the client if the ordered e-book eventually becomes a “clean” copy, i.e., free of advertisements. The advertisement manager program that automatically carries out the advertisement removal can be written in a script language executable in the client device. The criteria of when and which advertisement to be removed is determined by the advertisement manager program which is predetermined by the e-book seller and in turn dictated by advertisers. The e-book seller can also combine the client's desires with needs of the advertisers in forming such criteria. The client's desire can be entered into the e-book seller's system through the client interest survey.

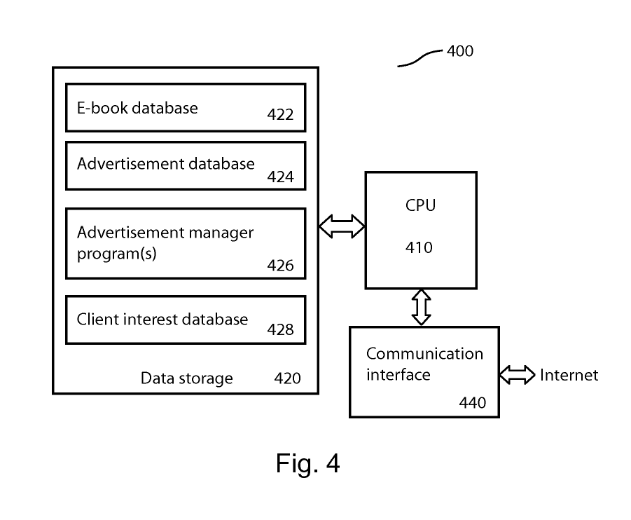

FIG. 4 is a block diagram illustrating a computer system 400 that performs the aforementioned steps as shown in FIG. 3. The computer system 400 includes at least a central processing unit (CPU) 410, a data storage device 420 and a communication interface 440. The communication interface 440 connects the e-book seller's computer system 400 to the Internet. The CPU 410 controls, among many other functions, a sending of the price-advertisement selection page to a client device through the communication interface 440. When a price-advertisement selection value is received by the computer system 400, the CPU 410 determines whether or not the client allows advertisements to be inserted in an ordered e-book based on the selection value. The CPU also determines a level of the amount of the advertisements to be inserted in the selected e-book based on the selection value. In a case that advertisements can be inserted in the selected e-book, the CPU 410 controls a gathering of client's interests by sending a survey page to the client device through the communication interface 440. The CPU 410 can also read out a subject of the selected e-book which apparently reflects the client's interests. The CPU 410 controls a selection of advertisements that best fit the client's interests. The CPU 410 searches through the selected e-book for suitable locations to insert the advertisements. The locations may be pre-marked by a publisher of the ordered e-book, and can be empty spaces on pages or added pages after a cover page, table-of-content or end-of-chapters. Inserting the selected advertisements in the selected locations is also performed by the CPU 410. The CPU 410 then controls a transmission of the ordered e-book loaded with advertisements to the client device. Along with the e-book, the CPU 410 also constructs and then transmits an advertisement manager program to the client device. The advertisement manager program is executable in the client device and can automatically remove the inserted advertisements after a predetermined period of time, an expiration date and/or a number of times the inserted advertisements being displayed by the client device.

Referring again to FIG. 4, the data storage device 420 stores at least an e-book database 422, an advertisement database 424, one or more advertisement manager programs 426, and a client interest database 428. The e-book database 422 stores original e-books offered for sale by the e-book seller. A catalog of the e-book database 422 is provided to client device for the client to choose from. Apparently the e-book database may reside in a separate server computer due to its size. The advertisement database 424 includes advertisements intended to be inserted selectively in copies of the e-books. The advertisements are prepared by advertisers and may carry such information as field of relevance and expiration date, etc. The e-book seller uses the field of relevance to determine which advertisement may be interested by a particular client. Such determination is performed by the CPU 410. The e-book seller is paid for every advertisement being inserted in an e-book. The advertisement manager programs 426 are pre-written and executable in the client devices. The advertisement manager programs 426 may take in parameters catered to a particular client and/or advertisements from the CPU 410 before being sent to the client device. The parameters may include which advertisement will be allowed to be displayed for how long. The client interest database 428 stores information collected from a client interest survey and from a subject of the ordered e-book. The information collection is again performed by the CPU 410.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A method for distributing an e-book over the Internet, the method comprising:
sending a selection page to a client device through the Internet, the selection page collecting a client's decision as to whether to order an e-book with or without advertisements;
inserting at least one advertisement in a predetermined location of a digital copy of an ordered e-book; and
transmitting the advertisement-inserted digital copy of the ordered e-book to the client device.

2. The method of claim 1 further comprising transmitting an advertisement manager program to the client device, the advertisement manager program being executable in the client device to automatically remove the inserted advertisement from the digital copy of the ordered e-book after a predetermined condition being met.

3. The method of claim 2, wherein the predetermined condition includes a predetermined length of time since the e-book is received by the client device, an expiration date or a number of times the inserted advertisement is displayed in the client device.

4. The method of claim 1 further comprising gathering the client's interests.

5. The method of claim 4, wherein the gathering the client's interests includes sending a survey page to the client device.

6. The method of claim 4, wherein the gathering the client's interests includes obtaining a subject of the ordered e-book.

7. The method of claim 4, wherein the inserted advertisement is selected based on the client's interest.

8. The method of claim 1, wherein the predetermined location of a digital copy of the ordered e-book is an empty space on an existing page of the ordered e-book.

9. The method of claim 1, wherein the predetermined location of a digital copy of the ordered e-book is an added page immediately subsequent to a cover page, a table-of-content, or an end-of-chapter of the ordered e-book.

10. A method for distributing an e-book over the Internet, the method comprising:
Sending a selection page to a client device through the Internet, the selection page collecting a client's decision as to whether to order an e-book with or without advertisements;
inserting at least one advertisement in a predetermined location of a digital copy of an ordered e-book;
transmitting the advertisement-inserted digital copy of the ordered e-book to the client device; and
transmitting an advertisement manager program to the client device, the advertisement manager program being executable in the client device to automatically remove the inserted advertisement from the ordered e-book after a predetermined condition being met.

11. The method of claim 10, wherein the predetermined condition includes a predetermined length of time since the e-book is received by the client device, an expiration date or a number of times the inserted advertisement is displayed in the client device.

12. The method of claim 10 further comprising gathering the client's interests.

13. The method of claim 12, wherein the gathering the client's interests includes sending a survey page to the client device.

14. The method of claim 12, wherein the gathering the client's interest includes obtaining a subject of the ordered e-book.

15. The method of claim 12, wherein the inserted advertisement is selected based on the client's interest.

16. The method of claim 10, wherein the predetermined location of a digital copy of the ordered e-book is an empty space on an existing page of the ordered e-book.

17. The method of claim 10, wherein the predetermined location of a digital copy of the ordered e-book is an added page immediately subsequent to a cover page, a table-of-content, or an end-of-chapter of the ordered e-book.

18. A system for distributing an e-book over the Internet, the system comprising:
a communication interface for connecting the system to the Internet;
an e-book database;
an advertisement database;
a central processing unit (CPU) configured to send a selection page to a client device through the Internet, the selection page collecting a client's decision as to whether to order an e-book from the e-book database with or without advertisements, the CPU configured to insert at least one advertisement from the advertisement database in a predetermined location of a digital copy of an ordered e-book, and to transmit the advertisement-inserted digital copy of the ordered e-book to the client device.

19. The system of claim 18 further comprising an advertisement manager program stored in a data storage device, the advertisement manager program being executable in the client device to automatically remove the inserted advertisement from the ordered e-book after a predetermined condition being met.

20. The system of claim 19, wherein the predetermined condition includes a predetermined length of time since the e-book is received by the client device, an expiration date or a number of times the inserted advertisement is displayed in the client device.

21. The system of claim 18, wherein the CPU is configured to gather the client's interests by sending a survey page to the client device, and the inserted advertisement is selected based on the client's interest.

22. The system of claim 18, wherein the CPU is configured to gather the client's interests by obtaining a subject of the ordered e-book, and the inserted advertisement is selected based on the client's interest.

23. The system of claim 18, wherein the predetermined location of a digital copy of the ordered e-book is an empty space on an existing page of the e-book.

24. The system of claim 18, wherein the predetermined location of a digital copy of the ordered e-book is an added page immediately subsequent to a cover page, a table-of-content, or an end-of-chapter of the e-book.
